(19) United States
(12) Patent Application Publication
(10) Pub. No.: US 2022/0289246 A1
(43) Pub. Date: Sep. 15, 2022

(54) METHOD, DEVICE, AND SYSTEM FOR CONTROLLING AUTONOMOUS VEHICLES

(71) Applicant: Siemens Electronic Design Automation GmbH, München, Bayern (DE)

(72) Inventors: Nizar Sallem, San Jose, CA (US); Richard Szabo, München (DE)

(21) Appl. No.: 17/633,187

(22) PCT Filed: Jun. 23, 2020
(86) PCT No.: PCT/EP2020/067489

§ 371 Date: Feb. 4, 2022

Related U.S. Application Data
(60) Provisional application No. 62/883,362, filed on Aug. 6, 2019.

(51) Int. Cl. B60W 60/00; G05D 1/00; G06F 8/65

(52) U.S. Cl. CPC B60W 60/0027; G05D 1/0055; G06F 8/65; B60W 2556/10; B60W 2554/402; B60W 2554/20

(57) ABSTRACT

A method, a controller, and a system for controlling autonomous vehicles are disclosed. The controller includes a firmware module configured to control an autonomous vehicle. The firmware module includes an event module configured to process safety critical components in an environmental model of the autonomous vehicle to generate emergency control signals to control a behavior of the autonomous vehicle with priority. The firmware module also includes a transaction module configured to update the environmental model by transactional processing of sensor data from sensing units of the autonomous vehicle. At least one of the safety critical components and non-safety critical components of the environmental model are updated.

### PRIORITY

This application is the National Stage of International Application No. PCT/EP2020/067489, filed Jun. 23, 2020, which claims the benefit of U.S. Provisional Patent Application Serial No. 62/883,362 filed on Aug. 66, 2019. The entire contents of these documents are hereby incorporated herein by reference.

### TECHNICAL BACKGROUND

The present embodiments relate to autonomous vehicles capable of land, water, and aerial movement. Particularly, the present embodiments relate to controlling the autonomous vehicles.

### BACKGROUND

Autonomous vehicles include multiple sensing and actuating units that are used for navigation. The autonomous vehicles also include controllers that interface with the sensing and actuating units for control and supervision.

It may be necessary for the controllers to recognize and react to an increased number of complex scenarios. The controller may classify information associated with the autonomous vehicles into safety critical information and knowledge base. The classification recognizes that the safety critical information and the knowledge base have different processing requirements. For example, processing of safety critical information is to be carried as fast as possible. This may enable avoidance of a critical situation. Knowledge base may require deep processing of sensor data to enhance accuracy. With higher accuracy, the controller may be able to take better decisions.

One approach to address the different requirements is by reaching a tradeoff between processing safety critical information and accuracy. However, the complexity of the environment may impact the tradeoff. For example, empty environment is less complex than an obstructed environment. The change from a less complex environment to a complex environment may occur very quickly. Therefore, by having the tradeoff, the autonomous vehicles may operate at sub-optimal levels in real-time.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a method, device, and system for controlling an autonomous vehicle by decoupling safety critical information are provided. As another example, a link between knowledge base and the safety critical information to enable processing of safety critical information while maintaining accuracy is provided.

A first aspect is a controller for controlling at least one autonomous vehicle. The controller includes a firmware module configured to control the autonomous vehicle. The firmware module includes an event module configured to process safety critical components in an environmental model of the autonomous vehicle to generate emergency control signals to control the autonomous vehicle. As used herein, the environmental model acts as the knowledge base and is a digital representation of the autonomous vehicle and an environment associated with the autonomous vehicle. As used herein, the safety critical components include data from the digital representation critical to the safety of the environment and the autonomous vehicle. The firmware module also includes a transaction module configured to update the environmental model by transactional processing of sensor data from sensing units of the autonomous vehicle, whereby the safety critical components and/or non-safety critical components of the environmental model are updated. As used herein, the non-safety critical components include data from the environmental model not critical to the safety of the environment and/or autonomous vehicle.

In an embodiment, the event module may be configured to process the safety critical components and generate the emergency control signals irrespective of the update to the transaction module.

In yet another embodiment, the transaction module may be configured to define the updates as transactions performed on the environmental model using the sensor data, the predicted updates, or a combination thereof. The transactions include insertion, deletion, modification of the object parameters in the occupancy map. The transactions are executed as atomic, recoverable operations.

A second aspect is a system for controlling at least one autonomous vehicle. The system includes sensing units configured to generate sensor data indicating environment of the autonomous vehicle. As used herein, the sensor data indicates position, location of the autonomous vehicle and objects in the environment. The system also includes a controller as described herein above. The controller is communicatively coupled to the sensing units and configured to generate control signals that control operation of the autonomous vehicle. The system may include actuating units configured to control operation of the autonomous vehicle based on the control signals.

A third aspect is a method of controlling at least one autonomous vehicle. The method includes identifying safety critical components in an environmental model of the autonomous vehicle. The environmental model is a digital representation of the autonomous vehicle and an environment associated with the autonomous vehicle. The safety critical components include data from the digital representation critical to the safety of the environment and the autonomous vehicle. The method includes generating emergency control signals to control operation of the autonomous vehicle based on the safety critical components. The method further includes updating the environmental model by transactional processing of sensor data from sensing units in the autonomous vehicle, whereby at least one of the safety critical components and non-safety critical components of the environmental model are updated. The non-safety critical components include data from the environmental model not critical to the safety of the environment and autonomous vehicle.

In an embodiment, the method may include defining updates to the environmental model as transactions to be performed on the environmental model. The updates are based on the sensor data or the predicted updates. Further, the method may include executing the transactions as atomic, recoverable operations. The transactions include insertion, deletion, modification of the object parameters in the occupancy map.

The above-mentioned and other features of the invention will now be addressed with reference to the accompanying drawings of the present invention. The illustrated embodiments are intended to illustrate, but not limit the invention.

### BRIEF DESCRIPTION OF THE DRAWINGS

FIG. 1 illustrates a block diagram of classification of sensor data, according to an embodiment;

FIG. 2 illustrates a block diagram of a controller for controlling an autonomous car, according to an embodiment;

FIG. 3 illustrates a block diagram of a system for controlling an unmanned aerial vehicle, according to an embodiment;

FIG. 4 illustrates a block diagram of a solution stack used by the controller in FIG. 2 and the system in FIG. 3, according to an embodiment; and

FIG. 5 illustrates a method of controlling one or more autonomous vehicles, according to an embodiment.

### DETAILED DESCRIPTION

Hereinafter, embodiments for carrying out the present invention are described in detail. The various embodiments are described with reference to the drawings, where like reference numerals are used to refer to like elements throughout. In the following description, for purpose of explanation, numerous specific details are set forth in order to provide a thorough understanding of one or more embodiments. It may be evident that such embodiments may be practiced without these specific details.

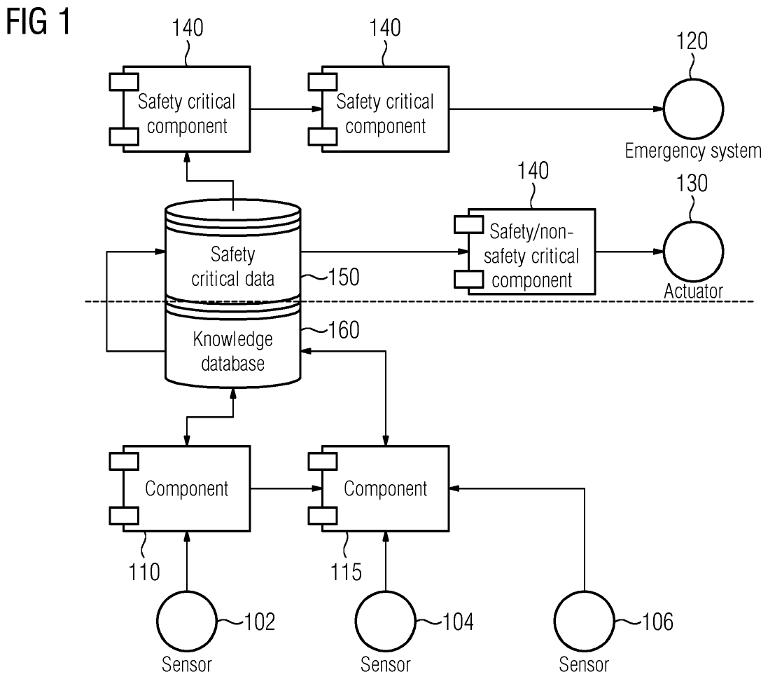

FIG. 1 illustrates a block diagram of classification of sensor data from sensing units 102, 104, and 106, according to an embodiment.

The sensing units 102, 104, and 106 are sensors that include but are not restricted to cameras, Light Detection and Ranging (LiDAR), Radar, Global Positioning System (GPS) sensors, Inertial Measurement Unit (IMUs), etc. Accordingly, the sensing units 102, 104, and 106 refer to any system/device capable of providing information on an autonomous vehicle and associated environment.

In FIG. 1, the sensing unit 102 is communicatively coupled to component 110. The sensing units 104 and 106 are communicatively coupled to component 115. In an embodiment, component 110 is a landing gear, and component 115 is a hood of the Unmanned Air Vehicle (e.g., autonomous vehicle). In the embodiment of the Unmanned Air Vehicle (UAV), the sensing unit 102 is configured to provide information regarding the environment below the UAV. Similarly, the environment above the UAV is sensed by the sensing units 104 and 106.

In another embodiment, the component 110 is a front door, and component 115 is a front bumper of an autonomous car. The sensing units 102 are configured to provide information to enable determination of side impact and lane departure. The sensing units 104 and 106 provide information regarding path clearance.

The sensor data from sensing units 102, 104, and 106 accordingly provide information regarding the environment. Individually, the sensor data from sensing units 102, 104, and 106 may not provide a comprehensive understanding of the environment. Accordingly, the sensor data may be fused and stored in a knowledge database 160.

The knowledge database 160 includes a database that stores an environmental model of the autonomous vehicle and the environment. The environmental model is a digital representation of the autonomous vehicle and the environment in real time.

The environmental model includes an object list of objects in the autonomous vehicle and the environment. As used herein, the objects include at least one of living objects, non-living objects, animate objects, and inanimate objects that may be in the autonomous vehicle or in the environment. For example, the objects include a passenger in the autonomous vehicle, pedestrians, other vehicles, buildings, etc.

Further, the environmental model includes an occupancy map of the objects and associated object parameters. As used herein, the object parameters define a status of the objects at a time instance and a relationship of the objects with respect to the autonomous vehicle. For example, a spatial relationship between the objects and the autonomous vehicle is stored in the occupancy map.

Safety critical components 140 in the environmental model is extracted for processing. The safety critical components 140 are identified based on safety critical data 150 in the environmental model. The safety critical data 150 indicates what object parameters are critical to the safety of the objects and the autonomous vehicle. The safety critical components 140 require immediate processing and therefore are processed without delay.

The processing of the safety critical components 140 may lead to the generation of control signals to the actuator units 130 and/or emergency control signals to emergency systems 120. As used herein, the emergency systems 120 include the actuator units 130 that are responsible for the safety of the autonomous vehicle and the objects. For example, the emergency systems 120 include a braking unit of the autonomous vehicle or air-bag unit.

The actuator units 130 include any component of the autonomous vehicle that impacts a behavior of the autonomous vehicle. For example, actuating units 130 include speed controllers, engine, propellers, landing gear, and chassis controllers, etc. The actuator units 130 may also be used to control the autonomous vehicle for non-critical scenarios.

The environmental model may be updated after the safety critical components 140 are processed. In an embodiment, the environmental model is updated by defining each update as a transaction. The transactions include insertion, deletion, modification of the object parameters in the occupancy map. The transactions are executed as an atomic, recoverable operation. Accordingly, the transaction-based updates provide that the updates to the environmental model are completed and the environmental model may be trusted. Accordingly, at any instance, guaranteed access to the latest environmental model is provided.

FIG. 1 also illustrates the process of controlling the autonomous vehicle based on information collected from the environment using different sensing units 102, 104, and 106. The sensor data is gathered at a central point or the knowledge database 160 to construct a first representation of the environment. The first representation is referred hereinabove as the environmental model. Part of the representation critical to the safety of the autonomous vehicle is decoupled from the rest of the representation. The environmental model is accessible to both safety critical components 140 and non-safety critical components. The safety critical components 140 consider this information as complete at the time of access and act based on it. The non-safety critical components may further distill the environmental model by: 1. Inserting information from the sensing units that are not directly related to the safety of the autonomous vehicle and the environment; 2. Aggregating information over time; and 3. Interpreting past knowledge in the light of current observations.

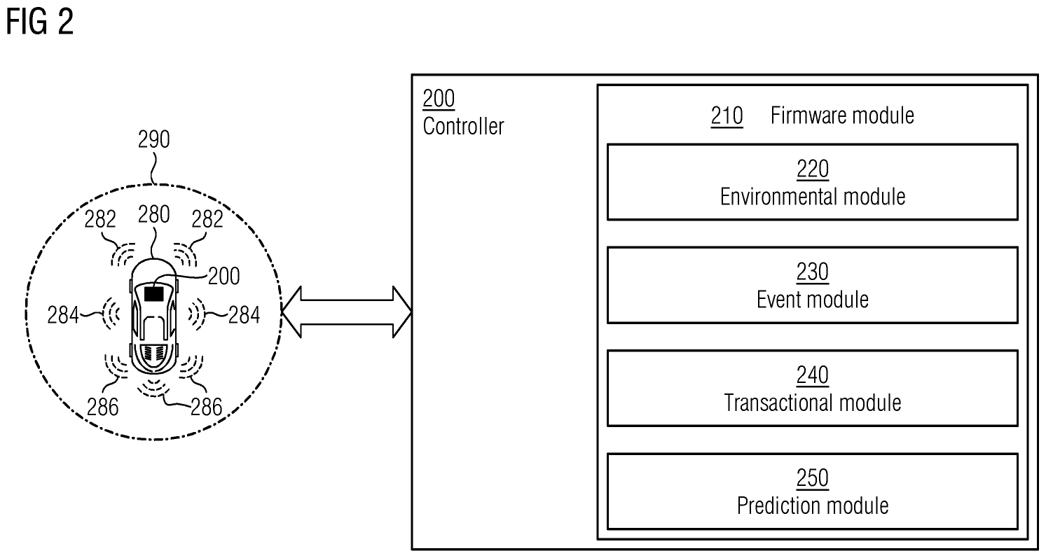

The above process is performed using a controller for controlling one or more autonomous vehicles. FIG. 2 illustrates a block diagram of a controller 200 for controlling an autonomous car 280, according to an embodiment.

The autonomous car 280 is provided with multiple sensing units 282, 284, and 286. The sensing units 282, 284, and 286 are configured to gather information regarding the autonomous car 280 and an environment 290 associated with the car 280. The autonomous car 280 includes actuating units (not shown in FIG. 2). The sensing units 282, 284, and 286 and the actuating units are communicatively coupled to the controller 200.

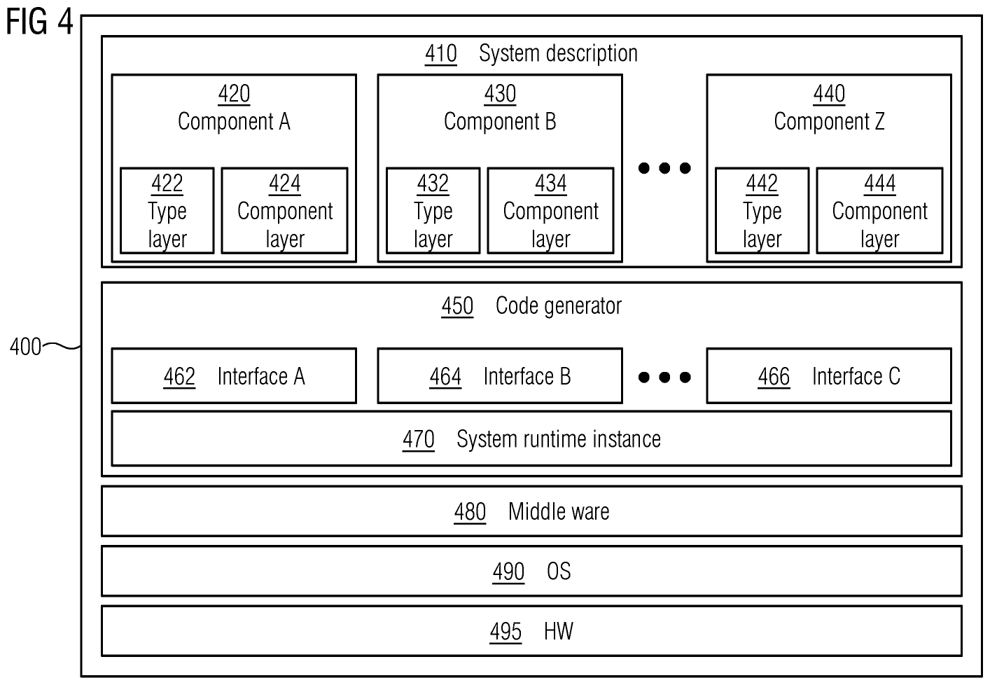

The controller 200 includes a firmware module 210. As used herein, the firmware module 210 refers to hardware and memory that are capable of executing and storing software instructions. As used herein, “memory” refers to all computer readable media (e.g., non-volatile media, volatile media, and transmission media except for a transitory, propagating signal). The memory stores the computer program instructions defined by modules (e.g., environment module 220, event module 230, transactional module 240, and prediction module 250). The architecture of the firmware 210 is further described in FIG. 4.

On execution of the modules in the firmware module 210, the controller 200 is capable of controlling the autonomous car 280. Each of the modules are discussed hereinafter.

The environment module 220 is configured to generate an environmental model from the sensor data generated by the sensing units 282, 284, and 286. The environmental model is a digital representation that is generated from the sensor data. The environment module 220 is configured to construct the digital representation using sensor fusion algorithms. In an embodiment, the sensor fusion algorithms are executed, by which the sensor data is analyzed to generate an object list in the car 280 and the environment 290. Accordingly, the environmental model includes the object list with the objects such as living objects, non-living objects, animate objects, and inanimate objects. Further, the environmental model includes an occupancy map of the objects and associated object parameters. The object parameters define a status of the objects at a time instance and a relationship of the objects with respect to the autonomous car 280. For example, the relationship of the objects may be defined spatially.

The environmental model enables the controller to interpret the environment 290. Further, a current and anticipated state of the car 280 is used to perform trajectory planning for the car 280. Further, the environmental model is constantly updated to enable route planning for the car 280. The updating of the environmental model may be performed as indivisible updates so that the integrity of the environmental model is maintained.

The event module 230 is configured to process safety critical components in the environmental model of the autonomous car 280 and the environment 290. The event module 220 is further configured to generate emergency control signals to control the autonomous car 280. The safety critical components include data from the environmental model that are critical to the safety of the environment 290 and the autonomous car 280. For example, an obstructing object in the environment 290 may be critical to the safety of the car 280, objects within the car 280, and the environment 290.

The environmental model is analyzed based on the information of an obstructing object. The classification of the object may not be considered while generating the emergency control signals. For example, the environmental model may misclassify an object as a tree instead of a pedestrian. The environmental model may be updated to correctly classify the object as a pedestrian. Nevertheless, the decision to avoid the object provides protection of the car 280, objects in the car 280, and the object/pedestrian. Accordingly, the event module 230 is configured to process the safety critical components irrespective of the update to the environmental model to generate the emergency control signals. As used herein, “emergency control signals” are control signals sent to actuator units of the car 280 to control the behavior of the car 280 on priority. The control signals may also be sent to emergency systems such as air-bag unit in the car 280.

The updating of the environmental model is performed by the transaction module 240. The transaction module 240 is configured to update the environmental model by transactional processing of the sensor data. As used herein, “transactional processing” refers to a technique of dividing the sensor data into individual, indivisible operations, referred to as transactions. The transactions complete or fail as a whole. Accordingly, the transaction has completed, or the transaction has been “rolled back” after failure. Transaction processing is advantageous, as the integrity of the environmental model is maintained in a known, consistent state.

The transaction module 240 is configured to update at least one of the safety critical components and non-safety critical components of the environmental model. The non-safety critical components include data from the environmental model not critical to the safety of the environment and autonomous vehicle. In an embodiment, the transaction module 240 is configured to define the updates as transactions performed on the environmental model using either the sensor data or predicted updates to the sensor data. For example, if the object begins to move, the predicted updates of the direction of movement may be updated in the environmental model. The transactions include insertion, deletion, and modification of the object parameters in the occupancy map. The transactions are executed as atomic, recoverable operations. Further, the transaction module 240 is configured such that two transactions cannot modify the environmental model at the same time.

The prediction module 250 is configured to predict updates to the environmental model based on historical sensor data. For example, the sensor data from a previous day for the same time is used as a reference to predict possible pedestrian traffic. The predicted updates are used by the transaction module 240 to define the transactions that update the environmental model. The prediction module 250 is used to interpret the historical sensor data in view of the sensor data received in real-time. Therefore, the environmental model when updated enables the controller 200 to take informed decisions.

The controller 200 is advantageous as the controller 200 satisfies the safety requirement by providing safety relevant information with the lowest possible latency. Further, the controller 200 harnesses as much knowledge as potentially available in the environment 290 without hindering the performance or sacrificing safety. The combination of the event module 230 and the transactional module 240 provides that the sensor data received from the sensing units 282, 284, and 286 will be accessible.

The event module 230 provides that the controller 200 is reactive: As soon as an event (e.g., a safety critical component) is identified, the appropriate action may be taken by the controller 200 with a least possible delay.

The event module 230 provides that the controller is flexible: The safety critical components may be organized in a hierarchy to give higher importance certain object parameters in the environmental model. Further, actions that be configured based on the safety critical components that are identified may be triggered.

Transactional module 240 also enables the controller 200 to respond to the updates with minimum response time. Further, the controller 200 is available to process events while updating the environmental model. In addition, the data integrity of the environmental is always protected. Further, the controller 200 may be modular and extended at incremental cost as the sensor data becomes larger or more components are to use the controller.

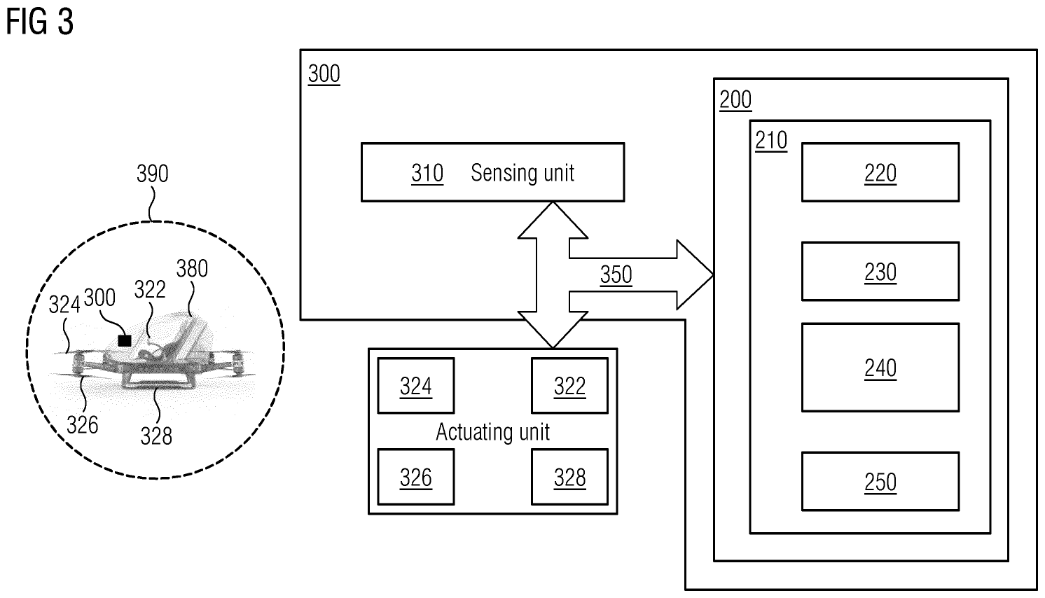

In certain embodiments, the controller 200 may include a central sensing unit where the sensor data is fused in real time at all levels. Such a control system is disclosed in FIG. 3.

FIG. 3 illustrates a block diagram of a system 300 for controlling an unmanned aerial vehicle 380, according to an embodiment.

The unmanned aerial vehicle 380 is an autonomous vehicle and includes multiple actuator units. In FIG. 3, example actuator units are indicated (e.g., a steering unit 322, a propeller 324, a braking unit 326, and a landing unit 328). Further, connecting the unmanned aerial vehicle 380 and the system 300 is a programmable network interface 350.

The network interface 350 is configured to provide communication among the sensing units, the actuating units, and/or the controller 200 using one or more of wired and wireless communication standards. For example, wired communication standards include Peripheral Component Interconnect Express (PCI-e) and Gigabit Ethernet and Flat Panel Display Link (FPD-Link). Wireless communication standard may include Bluetooth, ZigBee, Ultra Wide Band (UWB), and Wireless Local Area Network (WLAN). Examples of the network interconnect 350 include Controller Area Network (CAN), Local Interconnect Network (LIN), and Automotive Ethernet.

The system 300 includes a sensing unit 310, controller 200, and a programmable network interface 350. The sensing unit 310 includes a combination of data gathering devices (e.g., sensors and/or processors). In the sensing unit 310, sensor data having different types/formats (e.g., 2D, 3D, ADC, etc.) are fused. Further, in combination with the environment module 220, the sensor data at varying frame rates are combined into one time and spatially synced view referred to as the environmental model. The environmental model provides a digital representation of environment 390 and the unmanned aerial vehicle 280.

When the unmanned aerial vehicle 380 is in operation, the controller 200 is used to process events and update the environmental model. The operation of the controller 200 is similar to the description provided in FIG. 2. In an embodiment, the controller 200 includes Field Programmable Gate Array (FPGA) and is configured for the environmental model generation and sensor data fusion. Further, the controller 200 may include a System on Chip (SOC) for executing the event module 230, the transaction module 240, and the prediction module 250. In an embodiment, the controller 200 includes a Micro Controller Unit (MCU) for operating the network interface 350.

The present embodiments further include a solution stack 400 to enable event processing and transaction-based updating of the environmental model. FIG. 4 illustrates a block diagram of the solution stack 400 used by the controller 200 and the system 300, according to an embodiment.

The stack 400 includes a hardware layer 495. The hardware layer 495 may include one or more central processing units and/or FPGAs. Above the hardware layer 495 is an operating system layer 490. In an embodiment, the logic executed by the modules 220, 230, 240, and 250 of the present embodiments is independent of the hardware layer 495 and the operating system layer 490.

Above the operating system layer 490 is a middle-ware layer 480. The middle-ware layer 480 may include run-time dynamic libraries and/or transport libraries. Further, the middle-ware layer 480 may include abstraction libraries for operating system abstraction.

The operating system layer 480 is preceded by a code generator layer 450. The code generator layer 450 includes a system runtime instance layer 470 and component interfaces 462, 464, and 468. The code generator layer 450 synthetizes code from domain specific language. The code generator layer 450 generates package with the runtime instance and interface. The instances are made from components defined in component layer.

Above the code generator layer 450 is a system description layer 410. The system description layer 410 is defined for each component 420, 430, and 440. Each component includes a type layer 422, 432, 442, respectively. Further, each component includes the component layer 424, 434, 444, respectively.

The system description layer 410 enables updates to the environmental model to be described. The description is in terms of instances of components connected based on predetermined relationships. Each component may correspond to a semantic entity with a task in the system. A component is the parts of the system that create and process the updates to the environmental model. The updates may be described using the type layer 422, 432, 442.

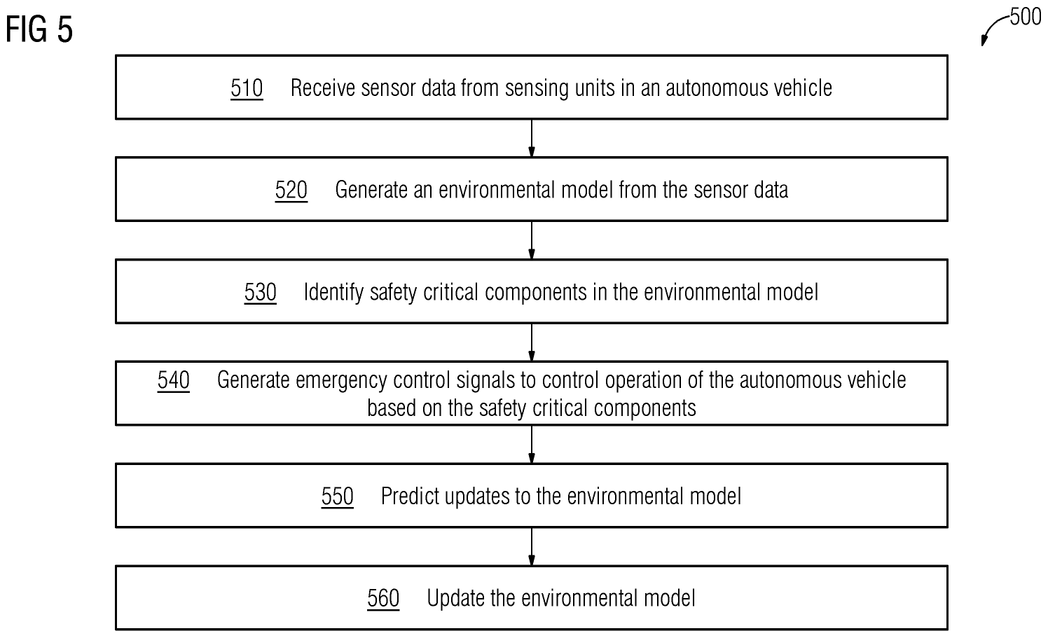

FIG. 5 illustrates a method 500 of controlling one or more autonomous vehicles, according to an embodiment. The method begins at act 510 by receiving sensor data from sensing units in an autonomous vehicle. The sensor data may include raw, unfiltered data from radar, light detection and ranging (LIDAR), vision and other sensors in real time.

At act 520, an environmental model is generated from the sensor data. The environmental model is a digital representation of the autonomous vehicle and an environment associated with the autonomous vehicle. As used herein, the environmental model may also include a first digital representation that is generated based on the sensor data using sensor fusion techniques. The first digital representation indicates the potential for the environmental model to dynamically evolve. In an embodiment, a controller will execute sensor fusion algorithms on the raw sensor data and generate an object list of the vehicle and an environment associated with the vehicle. The environment includes the surroundings of the vehicle.

The environmental model may include the object list of objects in the autonomous vehicle and the environment and an occupancy map. The objects include at least one of living objects, non-living objects, animate objects, and inanimate objects. A relationship of the objects with respect to the vehicle is mapped in the occupancy map. Accordingly, act 520 also includes generating the occupancy map including a map of the objects and associated object parameters. The object parameters define a status of the objects at a time instance and the relationship of the objects with respect to the autonomous vehicle.

At act 530, safety critical components in an environmental model are identified. The safety critical components include data from the digital representation critical to the safety of the environment and the autonomous vehicle (e.g., an obstruction that may cause injury to the objects in the autonomous vehicle or the environment). The safety critical components are identified by determining the safety critical data in the environmental model. For example, the object parameters may be used to determine the safety critical data.

At act 540, emergency control signals are generated to control operation of the autonomous vehicle based on the safety critical components. The emergency control signals are generated irrespective of the evolution of the environmental model. For example, the first digital representation of the environment and the autonomous vehicle is considered complete. Therefore, the safety critical components are decoupled from the process of updating the environmental model for higher accuracy.

At act 550, updates to the environmental model may be predicted based on historical sensor data. These updates are predicted based on prior environmental conditions using advanced neural networking algorithms for machine learning.

At act 560, the environmental model is updated. The act of updating includes defining updates to the environmental model as transactions to be performed on the environmental model. The updates may be based on the sensor data and/or the predicted updates. The transactions include insertion, deletion, and modification of the object parameters in the occupancy map.

The environmental model is updated by transactional processing of the transactions. In transactional processing, the transactions are executed as atomic, recoverable operations. During execution, the safety critical components and/or non-safety critical components of the environmental model are updated. As used herein, the non-safety critical components include data from the environmental model not critical to the safety of the environment and autonomous vehicle.

The present embodiments may take a form of a computer program product including program modules accessible from computer-usable or computer-readable medium storing program code for use by or in connection with one or more computers, processors, or instruction execution system. For the purpose of this description, a computer-usable or computer-readable medium may be any apparatus that may contain, store, communicate, propagate, or transport the program for use by or in connection with the instruction execution system, apparatus, or device. The medium may be electronic, magnetic, optical, electromagnetic, infrared, or a semiconductor system (or apparatus or device); propagation mediums in and of themselves as signal carriers are not included in the definition of physical computer-readable medium and include a semiconductor or solid state memory, magnetic tape, a removable computer diskette, random access memory (RAM), a read only memory (ROM), a rigid magnetic disk and optical disk such as compact disk read-only memory (CD-ROM), compact disk read/write, or DVD. Both processors and program code for implementing each aspect of the technology may be centralized or distributed (or a combination thereof) as known to those skilled in the art.

While the present invention has been described in detail with reference to certain embodiments, it should be appreciated that the present invention is not limited to those embodiments. In view of the present disclosure, many modifications and variations would be present themselves to those skilled in the art without departing from the scope of the various embodiments of the present invention, as described herein. The scope of the present invention is, therefore, indicated by the following claims rather than by the foregoing description. All changes, modifications, and variations coming within the meaning and range of equivalency of the claims are to be considered within their scope. All advantageous embodiments claimed in method claims may also be apply to system/apparatus claims.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A controller for controlling at least one autonomous vehicle, the controller comprising:
a firmware module configured to control the at least one autonomous vehicle, the firmware module comprising:
an event module configured to process safety critical components in an environmental model of the autonomous vehicle to generate emergency control signals to control a behavior of the at least one autonomous vehicle with priority, wherein the environmental model is a digital representation of the at least one autonomous vehicle and an environment associated with the at least one autonomous vehicle, and wherein the safety critical components include data from the digital representation that is critical to safety of the environment and the at least one autonomous vehicle; and
a transaction module configured to update the environmental model, the update of the environmental model comprising transactional processing of sensor data from sensing units of the at least one autonomous vehicle, whereby wherein at least one of the safety critical components and non-safety critical components of the environmental model are updated, and wherein the non-safety critical components include data from the environmental model not critical to the safety of the environment and the at least one autonomous vehicle.

2. The controller of claim 1, wherein the event module is further configured to process the safety critical components irrespective of the update to the environmental model to generate the emergency control signals.

3. The controller of claim 1, wherein the firmware module further comprises:
an environment module configured to generate the environmental model from the sensor data generated by the sensing units; and
a prediction module configured to predict updates to the environmental model based on historical sensor data.

4. The controller of claim 1, wherein the environmental model further comprises:
an object list of objects in the at least one autonomous vehicle and the environment, wherein the objects include living objects, non-living objects, animate objects, inanimate objects, or any combination thereof; and
an occupancy map of the objects and associated object parameters, wherein the object parameters define status of the objects at a time instance and a relationship of the objects with respect to the autonomous vehicle.

5. The controller of claim 4, wherein the transaction module is further configured to define the updates as transactions performed on the environmental model using of the sensor data, predicted updates, or a combination thereof,
wherein the transactions include insertion, deletion, modification of the object parameters in the occupancy map, or any combination thereof, and
wherein the transactions are executed as atomic, recoverable operations.

6. A system for controlling at least one autonomous vehicle the system comprising:
sensing units configured to generate sensor data indicating an environment of the at least one autonomous vehicle, wherein the sensor data indicates a position of the at least one autonomous vehicle, a location of the at least one autonomous vehicle, and objects in the environment; and
a controller communicatively coupled to the sensing units and configured to generate control signals that control operation of the at least one autonomous vehicle, the controller comprising:
a firmware module configured to control the at least one autonomous vehicle, the firmware module comprising:
an event module configured to process safety critical components in an environmental model of the at least one autonomous vehicle to generate emergency control signals to control a behavior of the at least one autonomous vehicle with priority, wherein the environmental model is a digital representation of the at least one autonomous vehicle and an environment associated with the at least one autonomous vehicle, and wherein the safety critical components include data from the digital representation that is critical to safety of the environment and the at least one autonomous vehicle; and
a transaction module configured to update the environmental model,
the update of the environmental model comprising transactional processing of sensor data from the sensing units of the at least one autonomous vehicle,
wherein at least one of the safety critical components and non-safety critical components of the environmental model are updated, and wherein the non-safety critical components include data from the environmental model not critical to the safety of the environment and the at least one autonomous vehicle.

7. The system of claim 6, further comprising:
a programmable network interface configured to provide communication among at least one of the sensing units; and
actuating units configured to control operation of the at least one autonomous vehicle based on the control signals,
wherein the actuating units and the controller use one or more of wired and wireless communication standards.

8. The system of claim 7, wherein the sensing units comprise a camera, Light Detection and Ranging (LiDAR), Radar, Global Positioning System (GPS) sensors, or any combination thereof, and
wherein the actuating units include a speed controller, an engine, a propeller, landing gear, or a chassis controller.

9. A method of controlling at least one autonomous vehicle, the method comprising:
identifying safety critical components in an environmental model of the at least one autonomous vehicle, wherein the environmental model is a digital representation of the at least one autonomous vehicle and an environment associated with the at least one autonomous vehicle, and wherein the safety critical components include data from the digital representation critical to safety of the environment and the at least one autonomous vehicle;
updating the environmental model, updating the environmental model comprising transactional processing sensor data from sensing units in the at least one autonomous vehicle, wherein at least one of the safety critical components and non-safety critical components of the environmental model are updated, and wherein the non-safety critical components include data from the environmental model not critical to the safety of the environment and the at least one autonomous vehicle;
generating emergency control signals to control operation of the at least one autonomous vehicle based on the safety critical components irrespective of the update to the environmental model.

10. The method of claim 9, further comprising:
receiving the sensor data from the sensing units in the at least one autonomous vehicle;
generating the environmental model from the sensor data, the generating of the environmental model from the sensor data comprising applying sensor fusion techniques,
wherein the environmental model further includes an object list of objects in the at least one autonomous vehicle and the environment, and an occupancy map, wherein the objects include of living objects, non-living objects, animate objects, inanimate objects, or any combination thereof.

11. The method of claim 10, wherein generating the environmental model further comprises:
generating the occupancy map including a map of the objects and associated object parameters, wherein the associated object parameters define status of the objects at a time instance and a relationship of the objects with respect to the at least one autonomous vehicle.

12. The method of claim 9, further comprising:
predicting updates to the environmental model based on historical sensor data.

13. The method of claim 10, wherein updating the environmental model by transactional processing further comprises:
defining updates to the environmental model as transactions to be performed on the environmental model,
wherein the updates are based on the sensor or the predicted updates.

14. The method of claim 13, further comprising:
executing the transactions as atomic, recoverable operations,
wherein the transactions include insertion, deletion, modification of the object parameters in the occupancy map, or any combination thereof.

15. In a non-transitory computer-readable storage medium that stores machine-readable instructions executable by a processing unit, to control at least one autonomous vehicle, the machine-readable instructions comprising:
identifying safety critical components in an environmental model of the at least one autonomous vehicle, wherein the environmental model is a digital representation of the at least one autonomous vehicle and an environment associated with the at least one autonomous vehicle, and wherein the safety critical components include data from the digital representation critical to safety of the environment and the at least one autonomous vehicle;
generating emergency control signals to control operation of the at least one autonomous vehicle based on the safety critical components;
updating the environmental model, the updating of the environmental model comprising transactional processing sensor data from sensing units in the at least one autonomous vehicle,
wherein at least one of the safety critical components and non-safety critical components of the environmental model are updated, and
wherein the non-safety critical components include data from the environmental model not critical to the safety of the environment and the at least one autonomous vehicle.

16. The non-transitory computer-readable storage medium of claim 15, wherein the machine-readable instructions further comprise:
receiving the sensor data from the sensing units in the at least one autonomous vehicle;
generating the environmental model from the sensor data, the generating of the environmental model from the sensor data comprising applying sensor fusion techniques,
wherein the environmental model further includes an object list of objects in the at least one autonomous vehicle and the environment, and an occupancy map, wherein the objects include living objects, non-living objects, animate objects, inanimate objects, or any combination thereof.

17. The non-transitory computer-readable storage medium of claim 16, wherein generating the environmental model further comprises:
generating the occupancy map including a map of the objects and associated object parameters, wherein the associated object parameters define status of the objects at a time instance and a relationship of the objects with respect to the at least one autonomous vehicle.

18. The non-transitory computer-readable storage medium of claim 16, wherein the machine-readable instructions further comprise:
predicting updates to the environmental model based on historical sensor data.

19. The non-transitory computer-readable storage medium of claim 15, wherein updating the environmental model by transactional processing comprises:
defining updates to the environmental model as transactions to be performed on the environmental model,
wherein the updates are based on the sensor data or the predicted updates.
